(19) United States
(12) Patent Application Publication
(10) Pub. No.: US 2016/0093904 A1
(43) Pub. Date: Mar. 31, 2016

(54) SECONDARY BATTERY RECUPERATOR SYSTEM

(71) Applicant: Robert Bosch GmbH, Baden-Wuerttemberg (DE)

(72) Inventors: Paul Albertus, Washington, DC (US); John F. Christensen, Elk Grove, CA (US); Timm Lohmann, Ludwigsburg (DE); Boris Kozinsky, Waban, MA (US); Nikhil Ravi, Mountain View, CA (US)

(21) Appl. No.: 14/959,208

(22) Filed: Dec. 4, 2015

Related U.S. Application Data
(63) Continuation-in-part of application No. 14/184,994, filed on Feb. 20, 2014.
(60) Provisional application No. 61/767,605, filed on Feb. 21, 2013.

(51) Int. Cl. H01M 8/04; H02J 7/00; H01M 10/48; H01M 12/08; H01M 10/42; H01M 10/44; B60L 11/18; H01M 4/38

(52) U.S. Cl. CPC H01M 8/04276; B60L 11/1809; H02J 7/0052; H01M 4/38; H01M 12/08; H01M 8/04201; H01M 8/04111; H01M 8/0432; H01M 8/04746; H01M 10/4242; H01M 10/425; H01M 10/44; H01M 10/486; H01M 2004/027

(57) ABSTRACT

A secondary battery system includes a battery system stack having at least one negative electrode, wherein the negative electrode includes an oxidizable metal. The secondary battery system further includes a cold trap or an expander, an optional compressor, an optional oxygen reservoir, and battery control system. The cold trap or expander having an inlet operably connected to the battery system stack, a first outlet operably connected to the battery system stack and a second outlet. The second outlet of the cold trap or the expander may optionally operably connected to the oxygen reservoir via the compressor. The oxygen reservoir having an outlet operably connected to the battery system stack.

### CROSS-REFERENCES TO RELATED APPLICATIONS

This application is a continuation-in-part of prior application Ser. No. 14/184,994, filed 20 Feb. 2014, the contents of which are hereby incorporated by reference in their entirety. This application also claims the benefit of prior Provisional Application No. 61/767,605, filed 21 Feb. 2013, the contents of which are hereby incorporated by reference in their entirety.

### FIELD

This patent relates generally to secondary batteries, and more particularly to metal/oxygen secondary batteries.

### BACKGROUND

Rechargeable lithium-ion batteries are attractive energy storage systems for portable electronics and electric and hybrid-electric vehicles because of their high specific energy compared to other electrochemical energy storage devices. As discussed more fully below, a typical Li-ion cell contains a negative electrode, a positive electrode, and a separator region between the negative and positive electrodes. Both electrodes contain active materials that insert or react with lithium reversibly. In some cases the negative electrode may include lithium metal, which can be electrochemically dissolved and deposited reversibly. The separator contains an electrolyte with a lithium cation, and serves as a physical barrier between the electrodes such that none of the electrodes are electronically connected within the cell.

Typically, during charging, there is generation of electrons at the positive electrode and consumption of an equal amount of electrons at the negative electrode, and these electrons are transferred via an external circuit. In the ideal charging of the cell, these electrons are generated at the positive electrode because there is extraction via oxidation of lithium ions from the active material of the positive electrode, and the electrons are consumed at the negative electrode because there is reduction of lithium ions into the active material of the negative electrode. During discharging, the exact opposite reactions occur.

When high-specific-capacity negative electrodes such as a metal are used in a battery, the maximum benefit of the capacity increase over conventional systems is realized when a high-capacity positive electrode active material is also used. For example, conventional lithium-intercalating oxides (e.g., LiCoO₂, LiNi_{0.8}Co_{0.15}Al_{0.05}O₂, Li_{1.1}Ni_{0.3}Co_{0.3}Mn_{0.3}O₂) are typically limited to a theoretical capacity of ˜280 mAh/g (based on the mass of the lithiated oxide) and a practical capacity of 180 to 250 mAh/g, which is quite low compared to the specific capacity of lithium metal, 3863 mAh/g. The highest theoretical capacity achievable for a lithium-ion positive electrode is 1794 mAh/g (based on the mass of the lithiated material), for Li₂O. Other high-capacity materials include BiF₃ (303 mAh/g, lithiated), FeF₃ (712 mAh/g, lithiated), Zn, Al, Si, Mg, Na, Fe, Ca, Cs, and others. In addition, other negative-electrode materials, such as alloys of multiple metals and materials such as metal-hydrides, also have a high specific energy when reacted with oxygen. Many of these couples also have a very high energy density.

Unfortunately, all of these materials react with lithium at a lower voltage compared to conventional oxide positive electrodes, hence limiting the theoretical specific energy. Nonetheless, the theoretical specific energies are still very high (>800 Wh/kg, compared to a maximum of ˜500 Wh/kg for a cell with lithium negative and conventional oxide positive electrodes, which may enable an electric vehicle to approach a range of 300 miles or more on a single charge.

A typical lithium/oxygen electrochemical cell 50 is depicted in FIG. 1. The cell 50 includes a negative electrode 52, a positive electrode 54, a porous separator 56, and a current collector 58. The negative electrode 52 is typically metallic lithium. The positive electrode 54 includes electrode particles such as particles 60 possibly coated in a catalyst material (such as Au or Pt) and suspended in a porous, electrically conductive matrix 62. An electrolyte solution 64 containing a salt such as LiPF₆ dissolved in an organic solvent such as dimethyl ether or CH₃CN permeates both the porous separator 56 and the positive electrode 54. The LiPF₆ provides the electrolyte with an adequate conductivity which reduces the internal electrical resistance of the cell 50 to allow a high power.

A portion of the positive electrode 52 is enclosed by a barrier 66. The barrier 66 in FIG. 1 is configured to allow oxygen from an external source 68 to enter the positive electrode 54 while filtering undesired components such as gases and fluids. The wetting properties of the positive electrode 54 prevent the electrolyte 64 from leaking out of the positive electrode 54. Alternatively, the removal of contaminants from an external source of oxygen, and the retention of cell components such as volatile electrolyte, may be carried out separately from the individual cells. Oxygen from the external source 68 enters the positive electrode 54 through the barrier 66 while the cell 50 discharges and oxygen exits the positive electrode 54 through the barrier 66 as the cell 50 is charged. In operation, as the cell 50 discharges, oxygen and lithium ions are believed to combine to form a discharge product Li₂O₂ or Li₂O in accordance with the following relationship:

$$Li ↔ {Li}^{+} + {e}^{-} ( negative electrode )$$

$$\frac{1}{2} {O}_{2} + 2 {Li}^{+} + 2 {e}^{-} {}_{catalyst} {Li}_{2} O ( positive electrode )$$

$${O}_{2} + 2 {Li}^{+} + 2 {e}^{-} {}_{catalyst} {Li}_{2} {O}_{2} ( positive electrode )$$

The positive electrode 54 in a typical cell 50 is a lightweight, electrically conductive material which has a porosity of greater than 80% to allow the formation and deposition/storage of Li₂O₂ in the cathode volume. The ability to deposit the Li₂O₂ directly determines the maximum capacity of the cell. For example, in order to realize a battery system with a specific energy of 600 Wh/kg or greater, a plate with a thickness of 100 μm must have a capacity of about 20 mAh/cm².

Materials which provide the needed porosity include carbon black, graphite, carbon fibers, carbon nanotubes, and other non-carbon materials. There is evidence that each of these carbon structures undergo an oxidation process during charging of the cell, due at least in part to the harsh environment in the cell (pure oxygen, superoxide and peroxide ions, formation of solid lithium peroxide on the cathode surface, and electrochemical oxidation potentials of >3V (vs. LAO).

While there is a clear benefit to couples that include oxygen as a positive electrode and metals, alloys of metals, or other materials as a negative electrode, none of these couples has seen commercial demonstration thus far because of various challenges. A number of investigations into the problems associated with Li-oxygen batteries have been conducted as reported, for example, by Beattie, S., D. Manolescu, and S. Blair, “High-Capacity Lithium—Air Cathodes,” Journal of the Electrochemical Society, 2009. 156: p. A44, Kumar, B., et al., “A Solid-State, Rechargeable, Long Cycle Life Lithium—Air Battery, ” Journal of the Electrochemical Society, 2010. 157: p. A50, Read, J., “Characterization of the lithium/oxygen organic electrolyte battery,” Journal of the Electrochemical Society, 2002. 149: p. A1190, Read, J., et al., “Oxygen transport properties of organic electrolytes and performance of lithium/oxygen battery,” Journal of the Electrochemical Society, 2003. 150: p. A1351, Yang, X. and Y. Xia, “The effect of oxygen pressures on the electrochemical profile of lithium/oxygen battery,” Journal of Solid State Electrochemistry: p. 1-6, and Ogasawara, T., et al., “Rechargeable Li₂O₂ Electrode for Lithium Batteries,” Journal of the American Chemical Society, 2006. 128(4): p. 1390-1393.

While some issues have been investigated, several challenges remain to be addressed for lithium-oxygen batteries. These challenges include limiting dendrite formation at the lithium metal surface, protecting the lithium metal (and possibly other materials) from moisture and other potentially harmful components of air (if the oxygen is obtained from the air), designing a system that achieves acceptable specific energy and specific power levels, reducing the hysteresis between the charge and discharge voltages (which limits the round-trip energy efficiency), and improving the number of cycles over which the system can be cycled reversibly.

In systems using oxygen as a reactant, the oxygen may either be carried on board the system or obtained from the atmosphere. There are advantages and disadvantages to both approaches. When using an on board system that reacts gaseous oxygen in a closed format by use of a tank or other enclosure for the oxygen, one advantage is that if the reaction chemistry is sensitive to any of the other components of air (e.g., H₂O, CO₂), only pure oxygen can be added to the enclosure so that such contaminants are not present. Additional advantages include that the use of an enclosure can allow for the operation at a high partial pressure of oxygen at the site of the reaction (for uncompressed atmospheric air the pressure of oxygen is only 0.21 bar), and can prevent any volatile species from the leaving the system (i.e., prevent “dry out”). In order to further realize the advantages that come with the use of a closed system it is necessary to compress the oxygen so that the oxygen volume is not too large to transport. In particular, a pressure in the fully charged state of greater than 100 bar, such as about 350 bar (about 5000 psi), is desirable. Disadvantages to a closed system include the need to carry the oxygen at all times, increasing the system mass and volume, undesirable mixing with other materials, and potential safety issues associated with high-pressure oxygen. When using a system open to the atmosphere advantages include the system is smaller, lighter, and potentially less expensive compared to a closed system, less energy is consumed as oxygen compression for storage is not needed, and the lack of a compressor also result in less heat being generated by the system. Disadvantages to an open system include the possibility of contaminants entering the system and the potential to lose volatile species such as electrolyte which could reduce battery function and potentially be environmentally unfriendly.

### SUMMARY

What is therefore needed is a system to capture and reuse volatile materials evolved during the operation of the secondary battery.

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the invention are related to systems and methods for capturing and reusing materials evolved during the operation of secondary batteries, and more particularly to a system and method for capturing, separating, and reusing materials evolved during the operation of metal/oxygen secondary batteries.

In an embodiment, a secondary battery system comprising a battery system stack comprising at least one negative electrode, wherein the negative electrode comprises an oxidizable metal; a device or component for separating materials contained in a fluid stream, having an inlet operably connected to the battery system stack, having a first outlet operably connected to the battery stack and having a second outlet; an oxygen reservoir having an outlet operably connected to the battery system stack, and having an inlet; and a compressor having an outlet operably connected to the inlet of the oxygen reservoir, and having an inlet operably connected to the second outlet of the cold trap or expander.

In a further embodiment, a secondary battery system comprising a battery system stack comprising at least one negative electrode, wherein the negative electrode comprises an oxidizable metal; an expander having an inlet operably connected to the battery system stack, and having an outlet operably connected to the battery system stack to return captured electrolyte to the battery stack.

In a further embodiment, a method of operating a secondary battery system comprising charging a secondary battery system stack including at least one positive electrode including a form of an oxidized metal; transferring fluid formed by charging the secondary battery system stack to a cold trap or expander; separating, in the cold trap or expander, at least one material from the fluid to obtain a separated material; obtaining a signal generated by at least one sensor associated with the secondary battery system; and controlling a flow of the separated material to the secondary battery stack based upon the obtained signal.

The details of one or more features, aspects, implementations, and advantages of this disclosure are set forth in the accompanying drawings, the detailed description, and the claims below.

### BRIEF DESCRIPTION OF THE DRAWINGS

FIG. 1 depicts a prior art lithium-oxygen (Li/oxygen) cell including two electrodes, a separator, and an electrolyte;

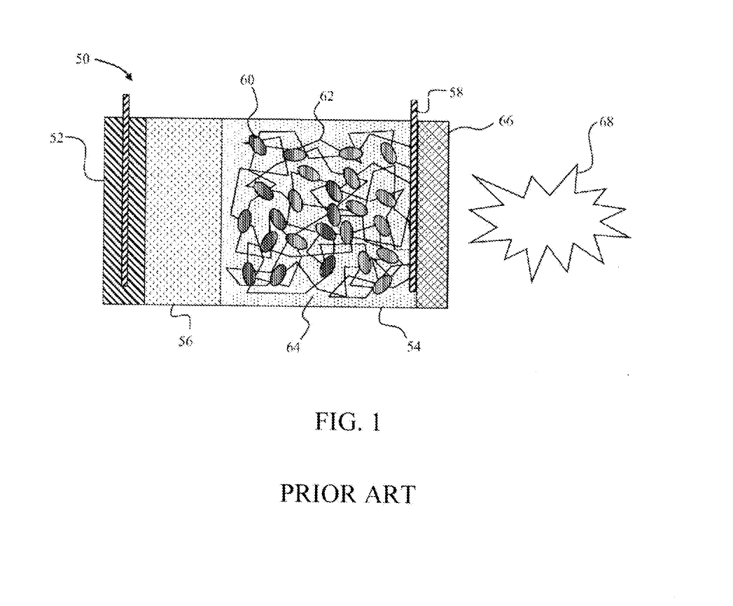

FIG. 2 depicts a schematic view of a secondary battery system with an adiabatic compressor operably connected to a reservoir configured to exchange oxygen with a positive electrode for a reversible reaction with lithium in accordance with a described disclosure;

FIG. 3 depicts a schematic view of another described example of a secondary battery system with a cold trap operably connected to the battery stack to return captured electrolyte and a compressor operably connected to an oxygen reservoir configured to exchange oxygen with a positive electrode for a reversible reaction with lithium;

FIG. 4 depicts a schematic view of another described example of a secondary battery system with an expander operably connected to the battery stack to return captured electrolyte and a compressor operably connected to a reservoir configured to exchange oxygen with a positive electrode for a reversible reaction with lithium;

FIG. 5 depicts a schematic view of another described example of a secondary battery system with an expander operably connected to the battery stack to return captured electrolyte while venting other fluids to the atmosphere;

FIG. 6 depicts a chart showing the increase in temperature when a gas is adiabatically compressed starting from a pressure of 1 bar and a temperature of 298.15 K with constant gas properties (i.e., gamma) assumed; and

FIG. 7 depicts a chart showing compression work for an ideal gas (diatomic and constant properties are assumed for adiabatic) as a function of pressure with the initial pressure at one bar.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such development effort might be complex and time consuming, but would nevertheless be a routine undertaking of design, fabrication, and manufacture for those of ordinary skill having the benefit of this disclosure.

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

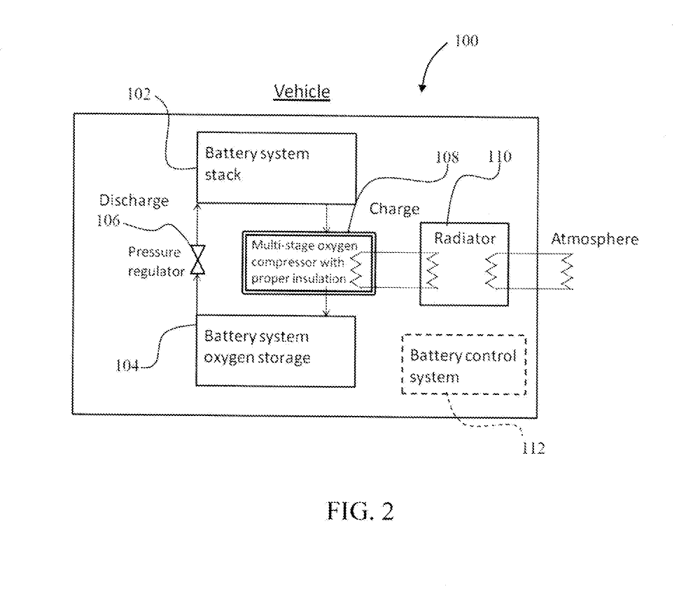

An embodiment of a vehicle 100 comprising a secondary battery system is shown in FIG. 2. The vehicle 100 includes a secondary battery system stack 102 and a battery system oxygen storage or an oxygen reservoir 104. A pressure regulator 106 governs provision of oxygen to the secondary battery system stack 102 during discharge while a multi-stage oxygen compressor 108 is used to return oxygen to the oxygen reservoir 104 during charging operations. A cooling system or radiator 110 is used to cool the compressed oxygen between stages of the multi-stage compressor.

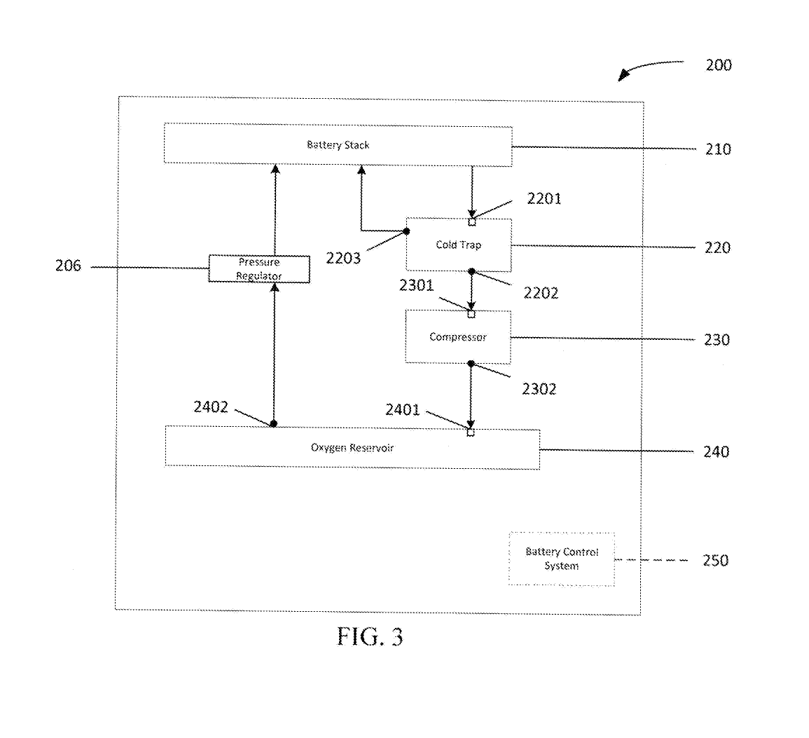

An embodiment of a secondary battery system 200 is shown in FIG. 3. The secondary battery system 200 includes a pressure regulator 206, a battery stack 210, a cold trap 220 having an inlet 2201 and outlets 2202 and 2203, a compressor 230 having an inlet 2301 and an outlet 2302, an oxygen reservoir 240 having an inlet 2401 and an outlet 2402, and a battery control system 250.

During battery charging the temperature of the battery stack 210 may increase as energy is input for storage in the system 200. This increase in temperature may cause evaporation of the electrolyte solution, and any other volatile materials present, hereinafter known as electrolyte. This evaporated electrolyte may be contained in the fluid stream formed by the liberation of oxygen, O₂, produced during charging. The mixed fluid stream of oxygen and electrolyte may be passed through a device for separating materials contained in a fluid stream, such as, by passing the fluid stream through the cold trap 220 in order to separate the electrolyte from the oxygen. The mixed fluid stream flows into the inlet 2201 of the cold trap 220, and the separated electrolyte may then be returned to the battery stack 210 via the outlet 2203 of the cold trap 220 and reused. The remaining fluid stream now comprises purified oxygen and exits from the outlet 2202 of the cold trap 220 and then enters the inlet 2203 of the compressor 230 where it can then be compressed by the compressor 230 for storage in the oxygen reservoir 240. The stored oxygen may be returned to the battery stack 210 via the outlet 2402 of the oxygen reservoir 240 and through pressure regulator 206 during battery discharge if needed. In some embodiments, at least a portion of the remaining fluid may be vented to the atmosphere.

The cold trap 220 is used to separate materials contained in the fluid stream. The cold trap 220 allows the fluid stream to pass over surfaces of the cold trap, which may be cooled to induce condensation. Components of the fluid stream, such as electrolyte, may condense and subsequently be stored or returned to the battery stack 210. The cooling of the surfaces of the cold trap 220 may be accomplished by various methods, including, thermoelectric cooling, such as by the Peltier effect, contact with a coolant, such as dry ice or liquid nitrogen, or through the use of a vapor compression refrigeration system.

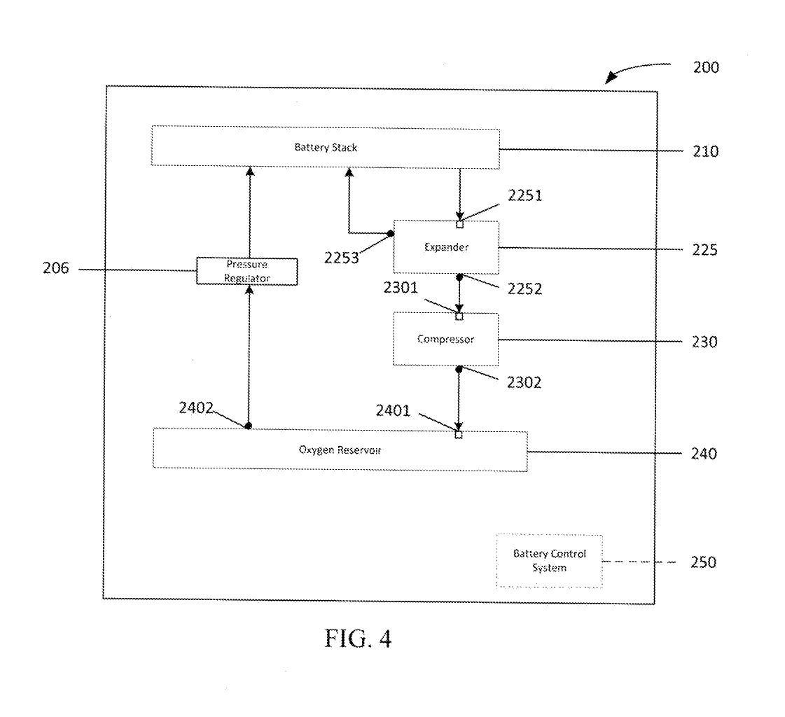

A further embodiment of a secondary battery system 200 is shown in FIG. 4. The secondary battery system 200 includes a pressure regulator 206, a battery stack 210, an expander 225 having an inlet 2251 and outlets 2252 and 2253, a compressor 230 having an inlet 2301 and an outlet 2302, an oxygen reservoir 240 having an inlet 2401 and an outlet 2402, and a battery control system 250.

The embodiment of FIG. 4 operates in like manner to the embodiment of FIG. 3 except the cold trap 220 is replaced by the expander 225. The expander 225 is used to separate materials contained in the fluid stream. The expander 225 allows the fluid contained in a region of higher pressure, such as the battery stack, to enter a region of lower pressure, such as the expander, for example, by passing through a valve. As the fluid enters the region of lower pressure it expands and cools. Components of the fluid stream, such as electrolyte, may condense and subsequently be stored or returned to the battery stack 210.

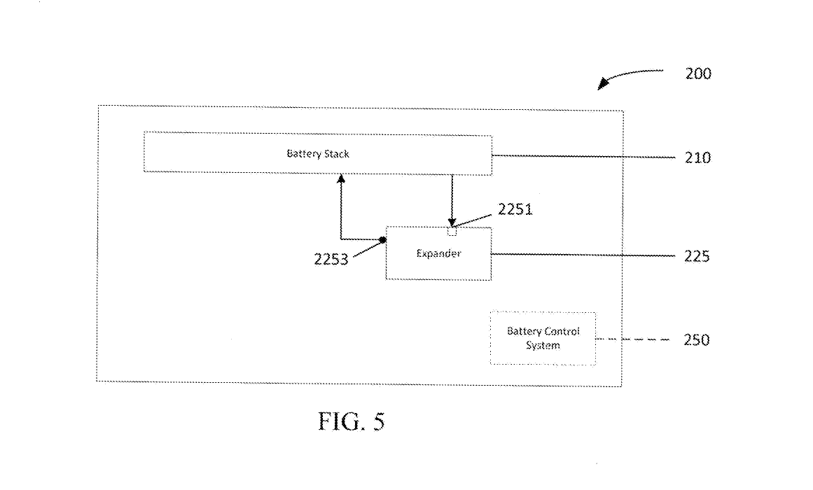

A further embodiment of a secondary battery system 200 is shown in FIG. 5. The secondary battery system 200 includes a battery stack 210, an expander 225 having an inlet 2251 and an outlet 2253, and a battery control system 250.

The embodiment of FIG. 5 operates in like manner to the embodiment of FIG. 4 except the compressor 230 and oxygen reservoir 240 illustrated in FIG. 4 are not present. Thus, the remaining fluid stream (the fluid stream not returning to the battery stack) exiting the expander 225 is vented to the atmosphere rather than compressed and stored in an oxygen reservoir for return to the battery stack 210.

The secondary battery system stack 102 or the battery stack 210 includes one or more negative electrodes separated from one or more positive electrodes by one or more porous separators. The negative electrode may be formed from lithium metal or a lithium-insertion compound (e.g., graphite, silicon, tin, LiAl, LiMg, Li₄Ti₅O₁₂), although Li metal affords the highest specific energy on a cell level compared to other candidate negative electrodes. Other metals may also be used to form the negative electrode, such as Zn, Mg, Na, Fe, Al, Ca, Cs, Si, and other materials that can react reversibly and electrochemically.

The positive electrode in one embodiment includes a current collector and electrode particles, optionally covered in a catalyst material, suspended in a porous matrix. The porous matrix is an electrically conductive matrix formed from a conductive material such as conductive carbon or a nickel foam, although various alternative matrix structures and materials may be used. The separator prevents the negative electrode from electrically connecting with the positive electrode.

The secondary battery system stack 102 or the battery stack 210 includes an electrolyte solution present in the positive electrode and in some embodiments in the separator. In some embodiments, the electrolyte solution includes a salt, LiPF₆ (lithium hexafluorophosphate), dissolved in an organic solvent mixture. The organic solvent mixture may be any desired solvent. In certain embodiments, the solvent may be dimethyl ether (DME), dimethyl sulfoxide (DMSO), acetonitrile (MeCN), ethylene carbonate, or diethyl carbonate. In other embodiments, an aqueous electrolyte is used (e.g., LiOH+LiCl or other Li salt in water or alcohol or a blend of water and alcohol). In still other embodiments, an inorganic molten salt or eutectic is used (e.g., blend of LiNO3, KNO3, NaNO3, CsNO3, LiNO2, and/or other alkaline or alkaline earth nitrites, nitrates, carbonates, etc.).

In the case in which the metal is Li, the secondary battery system stack 102 or the battery stack 210 discharges with lithium metal in the negative electrode ionizing into a Li⁺ ion with a free electron e⁻. Li⁺ ions travel through the separator toward the positive electrode. Oxygen is supplied from the oxygen reservoir 104, 240 through a pressure regulator 106, 206. Free electrons e⁻ flow into the positive electrode.

The oxygen atoms and Li⁺ ions within the positive electrode form a discharge product inside the positive electrode, aided by the optional catalyst material on the electrode particles. As seen in the following equations, during the discharge process metallic lithium is ionized, combining with oxygen and free electrons to form Li₂O₂ or Li₂O discharge product that may coat the surfaces of the carbon particles.

$$Li {Li}^{+} + {e}^{-} ( negative electrode )$$

$$\frac{1}{2} {O}_{2} + 2 {Li}^{+} + 2 {e}^{-} {\to }_{catalyst} {Li}_{2} O ( positive electrode )$$

$${O}_{2} + 2 {Li}^{+} + 2 {e}^{-} {\to }_{catalyst} {Li}_{2} {O}_{2} ( positive electrode )$$

In an embodiment the secondary battery system stack 102 or the battery stack 210 is part of a closed system which does not use air as an external source for oxygen. External sources, such as the atmosphere, may include undesired gases and contaminants. Thus, while the oxygen that reacts electrochemically with the metal in a metal/oxygen battery may come from the air, the presence of CO₂ and H₂O in air may reduce the service life of some of the media in which the metal/oxygen reactions are carried out and for some of the products that form. For example, in the reaction of Li with oxygen in which Li₂O₂ is formed, H₂O and CO₂ can react with the Li₂O₂ to form LiOH and/or Li₂CO₃, which can deleteriously affect the performance and rechargeability of the battery. As another example, in a basic medium CO₂ can react and form carbonates that precipitate out of solution and cause electrode clogging.

In FIGS. 2-5, all of the components are stored on board the vehicle. In the embodiment of FIGS. 2-5, the oxygen storage reservoir 104, 240 is separated from the secondary battery system stack 102 or the battery stack 210 where the reactions take place, but in other embodiments the oxygen storage is more closely integrated with the stack (for example, incorporated within the cells). In the embodiment of FIGS. 2-4, the oxygen storage is done in a tank or other enclosure that is spatially separated from the stack or cells where the reactions are carried out such that a minimal amount of high-pressure housing is required for the vehicle 100.

During discharge (in which oxygen is consumed), the pressure of the oxygen gas is reduced by passing it through the pressure regulator 106, 206 as depicted in FIGS. 2-4 such that the pressure of the oxygen that reaches the stack is close to ambient (i.e., less than about 5 bar). During discharge the compressor 108, 230 as depicted in FIGS. 2-4 does not operate. During charge the compressor 108, 230 is operated to compress the oxygen that is being generated within the stack or cells where the reactions are taking place.

The compressor 108, 230 in various embodiments is of a different type. In one embodiment which is suitable and mature for a vehicle application in which it is desired to pressurize a gas to more than 100 bar in a unit with a compact size is a multi-stage rotary compressor. When embodied as a multi-stage rotary compressor, each compression step is nearly adiabatic because it involves the rapid action of a piston to compress the gas. Commercial units of the appropriate size are widely available at a reasonable cost; they are used for a variety of applications that require air compression.

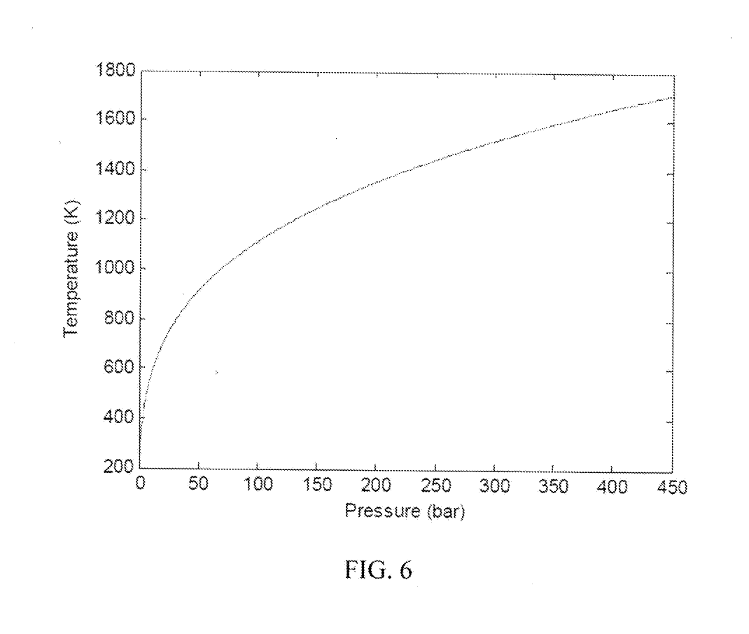

Because each stage of the compressor is nearly adiabatic, in addition to an increase in the pressure there is also an increase in the temperature, as explained with reference to FIG. 6. FIG. 6 shows the temperature at the end of a single adiabatic compression step starting at a pressure of 1 bar and a temperature of 298.15 K assuming constant gas properties. The figure shows that it is impractical to use a single compression step to achieve a pressure of, for example, 350 bar, because the output temperature would be far too high to inject into a tank of standard materials, which in turn is integrated in a vehicle that may have heat-sensitive components. In addition, the final pressure shown in FIG. 6 is for the temperature at the end of the compression step; thus, after cooling, the pressure will fall. It is important for the temperature of the compressed gas released into the tank to be within a certain range so that it is compatible with the tank material, which in different embodiments is a metal such as aluminum or a polymer, depending on the type of tank.

In some embodiments in order to prevent the temperature from rising too high it is necessary to cool the gas at the end of each adiabatic compression step. This is accomplished using the radiator 110 shown in FIG. 2. The radiator 110 in some embodiments is the same radiator that is used to cool the secondary battery system stack; in such embodiments the heat exchange loop also extends into the other components of the battery system such as the secondary battery system stack 102 and battery system oxygen storage 104. Typically, fluid is passed through the oxygen compressor 108, removing heat from the oxygen gas after each compression step and bringing the temperature towards that of the radiator fluid. The fluid is passed through the radiator 110 where heat is exchanged with the atmosphere. The compressor is also insulated to prevent the exposure of other parts of the battery system or the vehicle 100 to high temperatures.

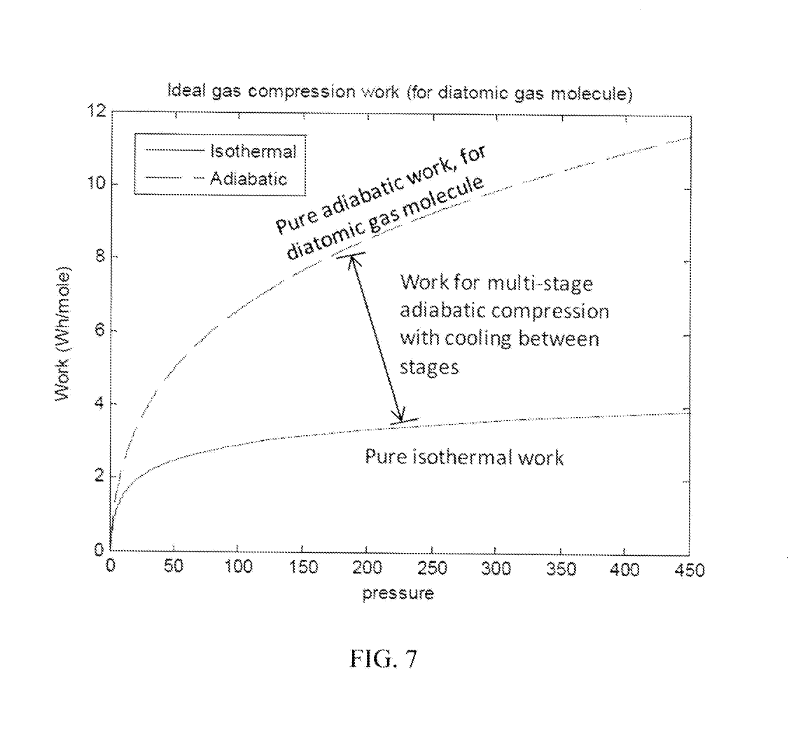

The cooling of the oxygen after each compression step allows the system to operate closer to the isothermal compression work line shown in FIG. 7. In particular, FIG. 7 shows the difference in the work required for a single-stage adiabatic compression (assuming a diatomic gas and constant properties) compared to the compression work required for isothermal compression. As the figure shows, significantly more work is required for adiabatic compression than isothermal compression. For a multi-stage adiabatic compression process with cooling between stages the amount of work required is between the pure isothermal and single-stage adiabatic lines. Thus, the amount of work required for the compression can be lowered compared to adiabatic compression by using multiple compression stages with cooling of the gas at the end of each compression.

The magnitude of the compression energy compared to the reaction energy also depends on the negative electrode material with which oxygen is reacting. For example, if the oxygen is reacting with Li to form Li₂O₂ on discharge, the reaction energy is 159 Wh/mole O₂. Thus, if the charging process takes place with 85% efficiency, about 24 Wh/mole O₂ would be required for cooling for the reaction, suggesting that the amount of cooling required for the compression should be smaller than that required for cooling the stack or cells.

In the embodiment of FIG. 2, all processes associated with the operation of the battery system are controlled by a battery control system 112. The battery control system 112 controls the flow rate of the fluid that is passed through the radiator 110 and the oxygen compressor 108 and possibly other components on the vehicle 100. The battery control system 112 includes a memory in which program instructions are stored and a processor which executes the program instructions to control the temperature of the oxygen which is compressed into the storage system 104. The processor is operatively connected to temperature sensors in the secondary battery system stack 102, the oxygen storage 104, the radiator 110, and at various stages in the compressor 108 in order to more precisely control the system. In some embodiments, more or fewer temperature sensors are included.

The secondary battery system stack 102 or the battery stack 210 thus makes use of oxygen (which may be pure or contain additional components) stored within a battery cell or external to a cell in a tank or other volume. The oxygen reacts electrochemically with the metal (which may include Li, Zn, Mg, Na, Fe, Al, Ca, Cs, Si, and others) to produce energy on discharge, and on charge the metal is regenerated and oxygen gas (and perhaps other species, such as H₂O) are evolved.

Beneficially, the battery system in the vehicle 100 is thus a completely closed system and species present in ambient air (e.g., H₂O, CO₂, and others) that may be detrimental to the cell operation are excluded. The battery system provides electrochemical compression of oxygen on charge, and the use of compressed oxygen on discharge, to reduce energy losses associated with mechanical oxygen compression (which is typically carried out adiabatically, including in a multi-stage adiabatic process) and to reduce the cost and complexity of a mechanical compressor. The components of the battery system are configured to handle the pressure of the compressed oxygen, including flow fields, bipolar plates, electrodes, separators, and high-pressure oxygen lines.

In the embodiments of FIG. 3 and FIG. 4, all processes associated with the operation of the battery system are controlled by a battery control system 250. The battery control system 250 controls the flow of materials through the components of the battery system including the battery stack 210, the cold trap 220 (when present), the expander 225 (when present), the compressor 230, and the oxygen reservoir 240 and possibly other components. The battery control system 250 includes a memory in which program instructions are stored and a processor which executes the program instructions to control conditions within the battery system. The processor is operatively connected to sensors which may measure one or more parameters of the battery system, including voltage, current, temperature, and pressure in the battery stack 210, the cold trap 220 (when present), the expander 225 (when present), the oxygen reservoir 240, and the compressor 230 in order to more precisely control the system. In some embodiments, more or fewer sensors are included.

In the embodiment of FIG. 5 all processes associated with the operation of the battery system are controlled by a battery control system 250. The battery control system 250 controls the flow of materials through the components of the battery system including the battery system stack 210, the expander 225, and possibly other components. The battery control system 250 includes a memory in which program instructions are stored and a processor which executes the program instructions to control conditions within the battery system. The processor is operatively connected to sensors which may measure one or more parameters of the battery system, including voltage, current, temperature, and pressure in the battery stack 210, the expander 225, in order to more precisely control the system. In some embodiments, more or fewer sensors are included.

In some embodiments in order to assist in returning the captured electrolyte to the battery stack at least one pump may be employed. The pump may be placed intermediate between at least one of the cold trap or expander and the battery stack. Operation of the pump may additionally be controlled by the battery control system.

The battery system in some embodiments includes high-pressure seals, an electrode, gas-diffusion layer, and flow field design that provide sufficient mechanical support to prevent pressure-induced fracture or bending (including with pressure cycling) that would be deleterious to cell performance and life, and a separator that is impervious to oxygen (even at high pressures, including up to 350 bar or above). The minimum pressure in some embodiments is chosen to eliminate delamination of cell components from one another. The minimum pressure in some embodiments is chosen to reduce mass transfer limitations and thereby increase the limiting current.

The above described system provides a number of advantages. For example, the use of a multi-stage compressor results in a vehicle with a closed battery system that is smaller and more economical, and with a higher efficiency, than other compression strategies.

Additionally, a higher oxygen pressure in the tank or reservoir can be achieved if the compressor is properly cooled than if there is not a good cooling solution. In addition the compression can be carried out more efficiently if the oxygen can be adequately cooled between each stage.

Moreover, the vehicle can be charged using only a wall outlet if a compressor is integrated into the vehicle system itself rather than stored externally from the vehicle.

Integration of the compressor on the vehicle allows for a completely closed gas handling system. If a compressor is stored separately from the vehicle a connection between the external compressor and the gas handling system on the vehicle may introduce contamination.

While the patent has been described with reference to various embodiments, it will be understood that these embodiments are illustrative and that the scope of the disclosure is not limited to them. Many variations, modifications, additions, and improvements are possible. More generally, embodiments in accordance with the patent have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A secondary battery system comprising:
a) a battery system stack comprising at least one negative electrode, wherein the negative electrode comprises an oxidizable metal;
b) a device for separating materials contained in a fluid stream from the battery system stack, the device having an inlet operably connected to the battery system stack, having a first outlet operably connected to the battery system stack and having a second outlet;
c) an oxygen reservoir having an outlet operably connected to the battery system stack, and having an inlet; and
d) a compressor having an outlet operably connected to the inlet of the oxygen reservoir, and having an inlet operably connected to the second outlet of the device.

2. The secondary battery system of claim 1:
wherein, the device comprises a cold trap.

3. The secondary battery system of claim 1:
wherein, the device comprises an expander.

4. The secondary battery system of claim 1:
wherein, the compressor is a multi-stage compressor comprising a first compression stage, a second compression stage, and a cooling system, and the cooling system is configured to provide a coolant to the multi-stage compressor to cool a compressed fluid between the first compression stage and the second compression stage.

5. The secondary battery system of claim 1:
wherein the oxidizable metal comprises a metal selected from the list consisting of: lithium, aluminum, sodium, calcium, cesium, iron, magnesium, or zinc.

6. A secondary battery system comprising:
a) a battery system stack comprising at least one negative electrode, wherein the negative electrode comprises an oxidizable metal; and
b) an expander having an inlet operably connected to the battery system stack, and having an outlet operably connected to the battery system stack to return captured electrolyte to the battery system stack.

7. The secondary battery system of claim 6:
wherein, the expander further comprises an outlet configured to vent remaining fluid to the atmosphere.

8. The secondary battery system of claim 6:
further comprising, an oxygen reservoir, and a compressor, the compressor comprising an inlet operably connected to the expander, and an outlet operably connected to the oxygen reservoir, wherein, the compressor is a multi-stage compressor comprising a first compression stage, a second compression stage, and a cooling system, and the cooling system is configured to provide a coolant to the multi-stage compressor to cool a compressed fluid between the first compression stage and the second compression stage.

9. The secondary battery system of claim 6:
further comprising, at least one sensor configured to generate a signal associated with a voltage within the secondary battery system;
a memory; and
a processor operably connected to the memory and the at least one sensor, the processor configured to execute program instructions stored within the memory to obtain the signal generated by the at least one sensor, and control a flow of a fluid to the battery system stack based upon the obtained signal.

10. The secondary battery system of claim 6:
further comprising, a pump, the pump configured to assist the flow of captured electrolyte from the expander to the battery system stack.

11. The secondary battery system of claim 6:
further comprising at least one sensor configured to generate a signal associated with a temperature within the secondary battery system.

12. The secondary battery system of claim 6:
further comprising at least one sensor configured to generate a signal associated with a current within the secondary battery system.

13. The secondary battery system of claim 6:
wherein the oxidizable metal comprises a metal selected from the list consisting of: lithium, aluminum, sodium, calcium, cerium, cesium, magnesium, or zinc.

14. A method of operating a secondary battery system comprising:
charging a secondary battery system stack including at least one positive electrode including a form of an oxidized metal;
transferring fluid formed by charging the secondary battery system stack to a cold trap or an expander;
separating, in the cold trap or expander, at least one material from the fluid to obtain a separated material;
obtaining a signal generated by at least one sensor associated with the secondary battery system; and
controlling a flow of the separated material to the secondary battery system stack based upon the obtained signal.

15. The method of claim 14:
wherein, the oxidized metal comprises a form of at least one of lithium, aluminum, sodium, calcium, cerium, cesium, magnesium, or zinc.

16. The method of claim 14:
further comprising, after separating the at least one material, releasing remaining fluid in the cold trap or expander to the atmosphere.

17. The method of claim 14:
further comprising, after separating the at least one material, transferring remaining fluid in the cold trap or expander to a compressor;
compressing the transferred fluid in the compressor; and
transferring compressed fluid from the compressor to a reservoir operably connected to the secondary battery system stack.

18. The method of claim 17:
wherein, the compressor is a multi-stage compressor, and wherein, compressing the transferred fluid further comprises, compressing the transferred fluid in a first compression stage of the multi-stage compressor;
compressing the compressed fluid from the first compression stage in a second compression stage of the multi-stage compressor; and
providing coolant to the multi-stage compressor.

19. The method of claim 14:
wherein, the compressed fluid comprises oxygen.
